(19) United States
(12) Patent Application Publication
(10) Pub. No.: US 2016/0004628 A1
(43) Pub. Date: Jan. 7, 2016

(54) PARALLEL TEST EXECUTION FRAMEWORK FOR MULTIPLE WEB BROWSER TESTING

(71) Applicant: Sunil Mallaraju Gugri, Bangalore (IN)

(72) Inventor: Sunil Mallaraju Gugri, Bangalore (IN)

(73) Assignee: Unisys Corporation, Blue Bell, PA (US)

(21) Appl. No.: 14/562,896

(22) Filed: Dec. 8, 2014

(30) Foreign Application Priority Data
Jul. 7, 2014 (IN) 1866/DEL/2014

(51) Int. Cl. G06F 11/36; H04L 29/08

(52) U.S. Cl. CPC G06F 11/3688; H04L 67/02; G06F 11/368; G06F 11/3692

(57) ABSTRACT

Computer implemented methods are provided for executing one or more test scripts in parallel across a plurality of web browsers. Such methods include receiving, by a server, a plurality of testing selections, the plurality of testing selections indicating one or more test scripts from a test script repository and identifying a plurality of web browsers to execute the one or more test scripts on one or more client machines; transmitting, by the server, to each of the one or more client machines instructions to launch the plurality of web browsers; distributing, by the server, one or more test scripts to each respective web browser on each of the one or more client machines, the plurality of web browsers executing the one or more test scripts transmitted by the server from the test script repository; and receiving, by the server, from the one or more client machines one or more results of executing the one or more test scripts by each of the plurality of web browsers of the respective client machine.

### TECHNICAL FIELD

The present application relates generally to testing for appropriate functionality of software currently under development across multiple web browsers.

### BACKGROUND

Recently, many commercial technology companies have distributed their applications or products as web services for customers. In the future, this trend may become even more popular as it avoids the overhead of installing application on every system which user uses. In existing automation frameworks of network testing environments, developers are often only capable of executing test scripts sequentially in one browser at-a-time. This method of testing demands considerable financial and human resources to complete the process; particularly testing software applications and products developed to operate on multiple web browsers. A new framework solution is needed to overcome the above problem, which will allow user to execute test scripts across different browsers in parallel on single system.

Software developers often develop software code in distributed-computing environments where networked computing devices may have diverse operating systems, software modules, hardware, firmware, browsers, and among other variations between components that may adversely affect compatibility of the code being developed. Similarly, software developers must develop software compatible with a vast array of web browsing and access environments hosted by networked devices. What is needed is a means for testing code being developed for software products to ensure that the code underlying the software will be compatible with various web browsers executing the code.

In many software development efforts, code development is often performed incrementally in the form of modular components of the software, sometimes referred to as classes, objects, or some other term of art depending upon the coding language being used that refers to its modules of code as representing a part of the whole software product. In this incremental development methodology, software code may be tested for efficient and effective performance as each smaller modular portion of the whole is completed. That is, smaller portions of code are often developed through testing before incorporating them into the whole. This incremental testing methodology contrasts with waiting to test the entire software application as whole, after completing the code in its entirety.

Often, developers utilize small chunks of code, so-called scripts, as mechanisms for testing incremental code portions of the whole software. Running test scripts across multiple web browsers typically requires significant effort to individually load each of the test scripts into specific systems having specific web browsers, and to then execute each of the test scripts. For example, sometimes test scripts may fail in one web browser but work in another, so in many cases it is necessary to identify whether scripts fail across multiple web browsers or the failure is limited to one type or one version of a particular web browser. It can be time consuming for developers to execute test scripts on each web browser. What is needed is a means for mitigating the time inefficiencies associated with selecting and executing test scripts across multiple web browsers to test for interoperability of software applications under development.

### SUMMARY

The systems and methods disclosed herein attempt to address the above-mentioned shortcomings in the art and provide a variety of other benefits. The systems and methods described herein can facilitate testing code and quickly finding successes and failures across diverse web browsers.

One embodiment includes a computer-implemented method for executing one or more test scripts in parallel across a plurality of web browsers. The method includes the steps of receiving, by a server, a plurality of testing selections, the plurality of testing selections indicating one or more test scripts from a test script repository and identifying a plurality of web browsers to execute the one or more test scripts on one or more client machines; transmitting, by the server, to each of the one or more client machines instructions to launch the plurality of web browsers; distributing, by the server, one or more test scripts to each respective web browser on each of the one or more client machines, the plurality of web browsers executing the one or more test scripts transmitted by the server from the test script repository; and receiving, by the server, from the one or more client machines one or more results of executing the one or more test scripts by each of the plurality of web browsers of the respective client machine.

In certain embodiments, each of the one or more results further indicate identity of each of the plurality of web browsers associated with the success or failure of executing the one or more test scripts. In certain embodiments, the one or more results of executing the one or more test scripts by each of the plurality of web browsers is one or more of the following: pass, partial fail, full fail, and error. In certain embodiments, the one or more results of executing the one or more test scripts by one among the plurality of web browsers is a partial fail when text is missing or not completely visible from one or more test script products, the test script product being obtained by executing the one or more test scripts by one among the plurality of web browsers. In certain embodiments, the one or more results of executing the one or more test scripts by one among the plurality of web browsers is a full fail when the one or more test scripts fail to be executed in a desired manner by one among the plurality of web browsers. In certain embodiments, the method further includes the step of communicating, by the server, the one or more results through an electronic interface responsive to the plurality of testing selections.

In certain embodiments, the method further includes the step of determining, by the server, whether the one or more client machines includes a framework module configured to execute the one or more test scripts; and transmitting, by the server, the framework module to the one or more client machines responsive to determining the one or more client machines do not contain the framework module. In certain embodiments, the method further includes the step of determining, by the server, whether the one or more client machines includes a framework module configured to launch a plurality of web browsers on each of the one or more client machines; and transmitting, by the server, the framework module to the one or more client machines responsive to determining the one or more client machines do not contain the framework module.

One embodiment includes a system for executing one or more test scripts in parallel across a plurality of web browsers. This system includes a test script repository storing one or more test scripts in a non-transitory machine-readable storage memory; a server receiving a plurality of testing selections, the plurality of testing selections indicating one or more test scripts from the test script repository and identifying a plurality of web browsers to execute the one or more test scripts on one or more client machines, wherein the server is further configured to transmit the plurality of testing selections to one or more client machines, and receive from the one or more client machines one or more results of executing the one or more test scripts by each of the plurality of web browsers; the one or more client machines executing the one or more test scripts using a plurality of web browsers responsive to the receiving the plurality of testing selections from the server; and one or more electronic interfaces configured to display to a user thereof the one or more results received by the server responsive to the plurality of testing selections.

In certain embodiments, the one or more client machines further contain one or more agent programs, each of the one or more agent programs configured to execute the one or more test scripts using one among the plurality of web browsers responsive to the receipt of the plurality of testing selections. In certain embodiments, each of the one or more agent programs is further configured to execute each of the one or more test scripts based on an associated priority. In certain embodiments, the associated priority for each of the one or more test scripts is determined by the user.

In certain embodiments, each of the one or more results further indicate identity of each of the plurality of web browsers associated with the one or more results of executing the one or more test scripts. In certain embodiments, the system further includes one or more results records, wherein one or more results records are updated by one or more agent programs with one or more results of executing the one or more test scripts by each of the plurality of web browsers.

In certain embodiments, the one or more results of executing the one or more test scripts by each of the plurality of web browsers is one or more of the following: pass, partial fail, full fail, and error. In certain embodiments, the one or more results of executing the one or more test scripts by one among the plurality of web browsers is a partial fail when text is missing or not completely visible from one or more test script products, the test script product being obtained by executing the one or more test scripts by one among the plurality of web browsers. In certain embodiments, the one or more results of executing the one or more test scripts by one among the plurality of web browsers is a full fail when the one or more test scripts fail to execute in a desired manner by one among the plurality of web browsers. In certain embodiments, further comprising one or more error queues, the one or more error queues configured to store and manage the one or more test scripts resulting in a full fail, the one or more test scripts having failed to execute in a desired manner by one among the plurality of web browsers

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings. It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification and illustrate an embodiment of the invention and together with the specification, explain the invention.

FIG. 1 illustrates a diagram of system architecture for a embodiment of a system for selecting and executing test scripts in parallel across multiple web browsers using a single client machine, according to an exemplary embodiment.

FIG. 2 illustrates a flow chart showing steps for a method according to the disclosed subject matter, according to an exemplary embodiment.

FIG. 3 illustrates a flow chart showing steps for a method according to the disclosed subject matter, according to an exemplary embodiment.

### DETAILED DESCRIPTION

Reference will now be made in detail to the preferred embodiments, examples of which are illustrated in the accompanying drawings. The embodiments described herein are intended to be exemplary. One skilled in the art recognizes that numerous alternative components and embodiments may be substituted for the particular examples described herein and still fall within the scope of the invention.

It should be appreciated test scripts may refer to software development tools, software code, and other machine-readable files prepared to effectively test certain aspects of a larger software development project. Although test scripts are particularly useful in larger object-oriented software development efforts, it should be appreciated that test scripts, code, software, processes, and modules are not intended to be limiting to large object-oriented software.

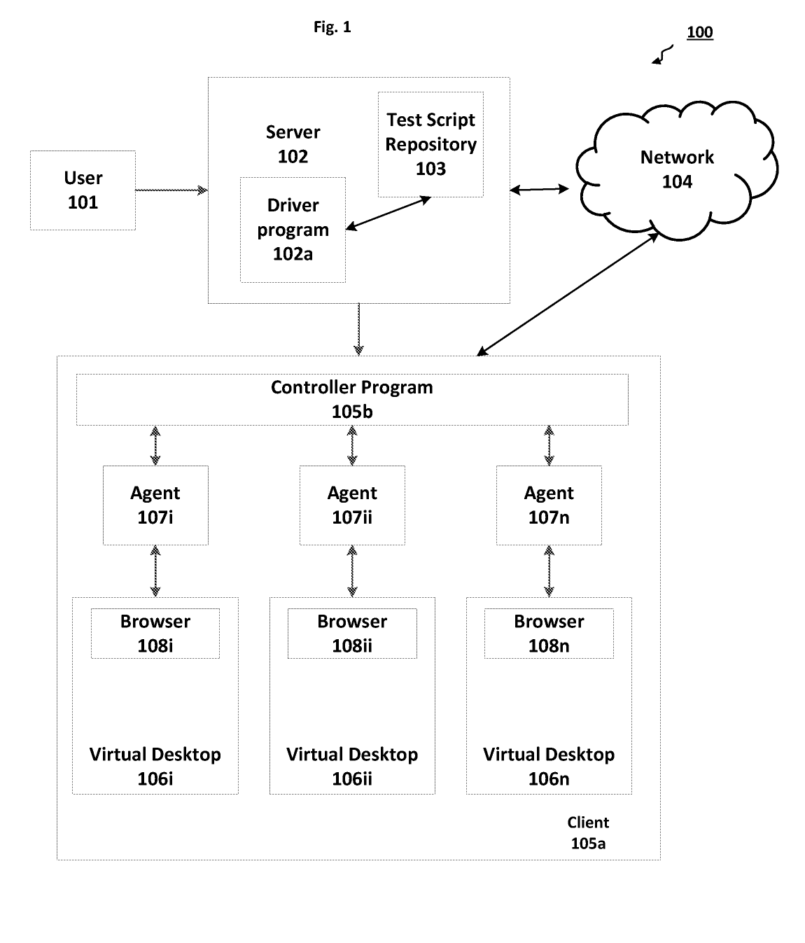

FIG. 1 is a diagram of system embodiment 100 for a software development system, showing constituent parts of a system that allows a user to execute test scripts across multiple web browsers in parallel on single device. A user 101 interacts with the components of the system embodiment 100 through server 102. A server 102 may be any computing device comprising non-transitory machine-readable storage media, processors, and software modules capable of performing various tasks and processes described herein. In an embodiment, a driver program 102a may be a software module component of the server 102 that, among other functions, provides an interface between users 101 and various resources of the system 100. A user interface, such as a graphical user interface, may provide a human-readable format for the driver program's 102a interface between users and the system 100. In an embodiment, the driver program 102a may interpret the results of the execution of the test scripts subsequent to being executed by one or more clients 105a. The driver program 102a is in communication with a test script repository 103, and is configured to generate a test file with test scripts for execution by one or more client machines 105a. The user interface is configured to receive selections regarding which test scripts will be executed by the client machines during testing and may also receive selections regarding which client machines will be targeted to receive the test scripts.

The server 102 may be any computing device comprising processors, non-transitory machine-readable memory, and/or software modules making embodiments of the server capable of executing various tasks and processes described herein. The server 102 may be any computing device placed in a central location of a computing network such that the server 102 may be communicatively coupled over a network to one or more software modules and devices, including client machines 105a in the system 100. The server 102 may execute a collection of one or more test scripts in order to test portions of computer code, which may be modular portions of a larger software project under development. When executing test scripts, the server 102 may subject code portion to the test scripts in order to verify proper functionality of the tested code portions. One or more servers 102 may be in communication with one or more client machines 105a. In certain embodiments, component features of the server 102 may reside on separate physical devices. For example, as exemplified in FIG. 1, the test script repository 103 in some embodiments can be a database containing test scripts and can be part of the server 102, however, in some embodiments the test script repository may reside on a different computing device than the server computer 102 (i.e., a distributed computing environment).

An embodiment of the invention includes a computing environment with a network 104 facilitating the communication between the servers 102 and client machines 105a. The network 104 is any common communication architecture that facilitates communication between computing devices. For example, in the embodiment of FIG. 1, the computing devices communicating over the network 104 would be the server 102 and the client machines 105a. One having ordinary skill in the art would appreciate that the network may be the Internet, a private intranet, or some hybrid of the two. The network 104 may be comprise any combination of devices and protocols capable of facilitating communication between computing devices. Non-limiting examples of devices comprising the network 104 may include routers, switches, hubs, firewalls, proxy servers, telecommunications trunks, and the like. Non-limiting examples of protocols employed by the network 104 may include TCP/IP, Wi-Fi, Bluetooth®, 3G, Wi-Max, and the like.

In operation, a user may select test scripts from a test script repository 103, the selected test scripts may then be distributed to client machines from a server 102. A client machine 105a is a computing device configured to interact with the server and the user and to run a plurality of test scripts. The client device may be, for example, a personal computing device with one or more web browsers. Other non-limiting examples of client machines include tablets, smart phones, and other electronic computing devices. Each of the client machines may have distinct operating systems, platforms, and/or web browsers. In other embodiments, each of the client machines may have similar operating systems, supporting a variety of web browsers. Client machines may be capable of supporting multiple web browsers.

In certain embodiments, client machines 105a comprise processors executing a controller program 105b that is configured to act as a communicator between the server 102 and the client machines 105a. The controller program 105b may control the overall execution of test scripts on each respective client machine 105a. It should be appreciated that the software modules described herein may be distributed among the devices of the system in varying permutations. For example, in certain embodiments, client machines 105a executing the controller program 105b can be configured to interact directly with the server 102 through the driver program 102a residing on the server 102, but in certain embodiments, client machines 105a can be configured to interact directly with the server 102 executing both the driver program 102a and the controller program 105b. In another embodiment, a controller 105b is a software module component executed directly by a server computer 102.

The controller program 105b in communication with the driver program 102a may be configured to create one or more agent programs 107 and corresponding virtual desktops 106. An agent program 107 acts as an interface between a web browser 108 and the controller 105b, and is configured to execute one or more test scripts. Each virtual desktop 106 can use an agent program 107 to run test scripts using a web browser 108, for example virtual desktop 106i uses agent program 107i to run test scripts using a web browser 108i, virtual desktop 106ii uses agent program 107ii to run test scripts using a web browser 108ii, and so on until virtual desktop 106n uses agent program 107n to run test scripts using a web browser 108n. where n is the number of web browsers selected by the user. In certain embodiments, the server 102 can instruct the client machines 105a directly to launch agent programs 107, and the corresponding virtual desktops 106 and web browsers 108. In certain embodiments, the controller program 105b in communication with the driver program 102a may be configured to create one or more virtual desktops 106 and corresponding agent programs 107. In certain embodiments, the server 102 can instruct the client machines 105a directly to launch virtual desktops 106, and the corresponding agent programs 107 and web browsers 108.

The test script repository 103 may be a non-transitory machine-readable storage medium storing test scripts designed to test portions of code for a software development project. It should be appreciated that the test script repository may be any combination of hardware and software components capable of storing test scripts and execute tasks as described herein. In some embodiments, the test script repository can be a database executing a database management system and storing test scripts in memory according to a database structure model. Some embodiments of the test script repository may comprise a file system storing test scripts in various directories. Some embodiments of the test script repository may be a text computer file containing the scripts. It should be appreciated that, in some embodiments, the test script repository may reside on a server 102 and that, in other embodiments, the test script repository may reside on a separate physical device to which the server may communicated with over a network.

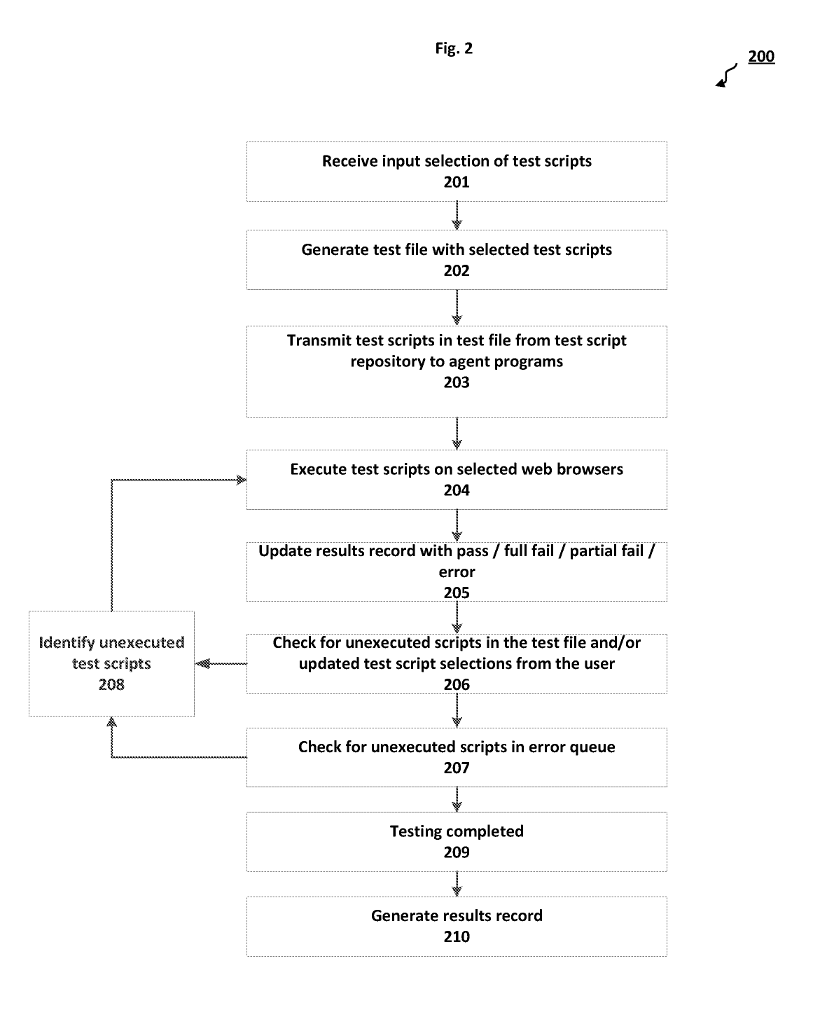

FIG. 2 is a flow chart showing steps for an exemplary method 200 showing how test scripts are executed across different browsers in parallel on a client machine, in accordance with the descriptions herein. In the first step 201, a server receives an input containing a selection of test scripts and a selection of web browsers. Test scripts are selected from a test script repository for testing the software or parts of it in multiple web browsers. For example, without limitations, a user may select to execute test scripts using one or more versions of one or more of Chrome, Firefox, Internet Explorer, Opera, and Safari. In some embodiments, a user may select which of the client machines on the network are intended to receive and execute the selected test scripts. In some embodiments, the user may interact with the test script repository using a user interface. In some embodiments, the user interface may be displayed on a server computer. In some embodiments, the user interface may be displayed on a remote computing device in networked communication with the server. In some embodiments, the user interface may be displayed by a mobile computing device, such as a laptop, smart phone, tablet or the like.

In a next step 202, a driver program may generate a test file containing the selected test scripts. In some embodiments, the server in communication with a test script repository may generate a test file containing the selected test scripts. Ahead of performing this step or subsequent to this step, the server or the driver program may determine whether selected client machines are in networked communication with the server and/or whether the selected client machines are configured to run the selected web browsers. That is, a client machine may be scheduled to receive a test script, however errors may arise if the client machine is not in networked communication with the server and/or if the selected client machines are not configured to run the selected web browsers. In such circumstances, the assigned test script may not be executed, and the user may be contacted regarding possible changes to the selection. In certain embodiments, the driver program may cause the server to transmit the requisite execution software to the client machines, and then instruct those client machines to install the execution software, so that the selected test scripts can be received and executed by the client machines.

In step 203, the test scripts are transmitted from the server to the client machine. In some embodiments, the test scripts are transmitted from the server to a controller program on the client machine. As shown in step 204, the test scripts are executed by the agent programs on selected web browsers. In some embodiments, the controller program initiates the execution of the test scripts by reaching out to each of the agent programs. Each agent program fetches one or more test scripts from test file based on priority and executes these test scripts on its respective web browser. The controller program may monitor the execution of the test script by the agent program, which may be executed using a framework software module for building and testing software code, such as a software development kit (SDK), and/or an integrated development environment (IDE), among others. The agent program is capable of testing code using test scripts on the different user selected browsers and returning the results to the controller program.

As described in step 205, results from execution of the test scripts may be a pass (successful), a fail (unsuccessful), and an error (e.g., unavailable resources). It should be appreciated that the manner such results are reported may vary, for example reporting the color green for a successful test script execution or the color red for an error. The result of the execution of a test script may be stored into a non-transitory machine-readable storage medium, such as a computer file or memory. When the agent program executes a particular test script and no error or failure is generated, that test script is marked as pass or success and the results are communicated to the controller program. The records in the successful or pass script list may contain, at least, the script ID of the script that was successful during execution, as well as the identification of the web browser than executed it. Other information that can be transmitted as part of the results record include identification of the client machine, time stamps, user identification, status of the network, and other system information.

The execution of the test scripts may sometimes result in one of two types of failure—a partial fail and/or a full fail. For example, without limitations, a partial fail results when the screen resolution does not match the required resolution to successfully execute the test script. For example, a partial fail results when some text is not completely visible or missing in web page following the execution of the test script. Another example for a partial fail includes an instance where some text or image is malformed in the web page following the execution of the test script. For example, without limitations, a full fail results when a functionality of the test script fails to perform in the desired manner. In certain embodiments, when the execution of a test script results in a partial fail, such as some text not completely visible or missing in web page, the agent program changes the resolution of the particular virtual desktop to one from standard resolution guidelines defined by user and runs the test script again on that browser. The new results are then communicated to the controller.

The results of the execution of the test scripts are communicated to the controller and then back to the driver program or the server. As shown in step 205, a results record is updated with the results of the execution of the selected test scripts on the selected web browsers. The test file is then checked in step 206 for any unexecuted scripts in the test file. In this step 206, the system may also check for are updated test script selections from the user. If these unexecuted test scripts are identified as in step 208, then these test scripts are sent to the agent programs and run on the selected web browsers. As shown in step 207. the system may also check for are unexecuted scripts in the error queue. The error queue is generated when a test script fails to be executed on a particular web browser. Then this particular test script is place on priority for testing on the other web browsers. For example, the error queue can be a database containing test scripts that failed to be executed on a particular web browser and can be part of the server, however the error queue may reside on a different computing device than the server computer. For example, if a particular test script fails on an Internet Explorer web browser, then it is placed on priority for testing with a Firefox web browser. If the test script happens to fail on both browsers, then the results record is updated or flagged for immediate review by the user. In certain embodiments, the results of the execution of the test scripts can be further analyzed or processed by a software program.

After completing the execution of a test script, each agent program fetches one or more test scripts from test file based on priority and execute these test scripts on its respective web browser until there are no more test scripts in the selected test file for execution, and the testing is complete as in step 209. Results from the agent programs executing the test scripts on one or more client machines are collected and stored as a results record, as in step 210. Although the results record is a logical component of the server computer, in some embodiments the results record may reside on a separate device, including the client machines. Depending upon the embodiment, the results record could be a database, a spreadsheet, a text file, or any other non-transitory machine-readable storage for storing an updatable set of results. The results produced by each agent program for the test scripts may be in the form of an execution result, an event log, or screenshots, or combinations thereof. In some embodiments, the agent program or the controller program monitoring the test script execution may generate an event log containing information describing the execution of the test script. In certain embodiments, the event logs may contain screenshots of the real-time information display of the results of the test script's execution, thereby capturing the visual information display for user's review.

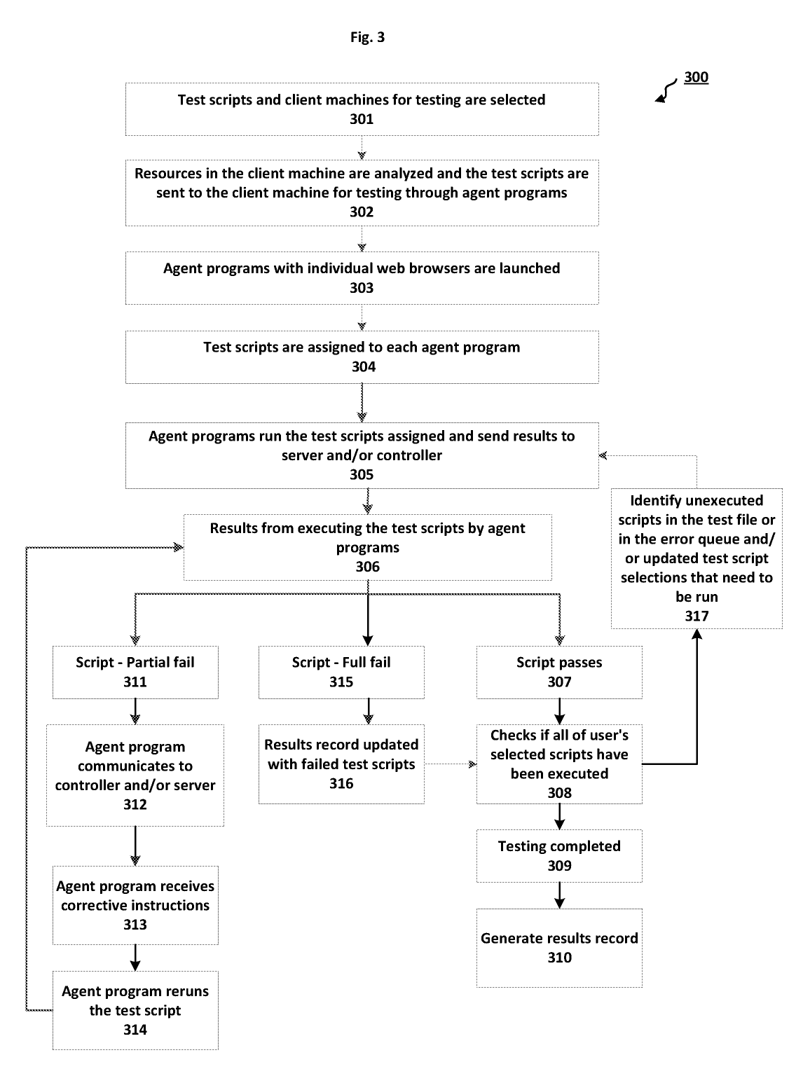

FIG. 3 is a flow chart showing steps for another exemplary method 300 showing how test scripts are executed across different browsers in parallel on a client machine, in accordance with the descriptions herein. Upon a user's instruction, the driver program is executed on the server. The user selects in step 301, through a user interface, one or more client machines to execute the tests, the number of test scripts that need to be executed, and the number and type of web browsers. The user interface facilitates user control and administration over test script execution. Using the user interface, the user can select test scripts for testing the software in different web browsers. For example, without limitations, a user may select to execute test scripts using one or more versions of one or more of Chrome, Firefox, Internet Explorer, Opera, and Safari. The user interface may comprise a request page for selecting tests scripts from a test script repository as previously described. The test script repository may hold more scripts than the user wishes to apply for testing. The user may select fewer client machines than that are present within the system to execute test scripts.

A test file may be generated by the driver program according to the user's selections from the request page. In some embodiments of the invention, a random selector is employed by the server to randomly select one or more test scripts to assign to client machines. In some embodiments, test scripts are associated with a unique script ID. In some embodiments, the random selector may randomly select one or more script IDs and send these script IDs to a driver program on the server. The driver program may distribute one script ID to each of the agent programs on the client machines such that each agent program receives one script ID corresponding to a test script. In certain other embodiments of the invention, the driver program sends a test file containing the selected test scripts to a controller program that then distributes the test scripts to the agent programs.

As shown in step 302, the driver program communicates with one or more client machines and initializes the platform for performing tests. This step includes but is not limited to checking the client machine for the presence of the selected web browsers and setting up the controller. Based on the user's selection regarding the types and the number of selected web browsers, the driver program will communicate with client machine's controller as in step 303 to create as many virtual desktops and corresponding agent programs on that client machine as the number of selected browsers. As described above, each virtual desktop can use an agent program to run test scripts using a web browser, for example one virtual desktop uses an agent program to run test scripts using a Chrome web browser, the second virtual desktop uses an agent program to run test scripts using a Firefox web browser, and so on. In certain embodiments, the number of virtual desktops and agent programs running test scripts using multiple web browsers is the same as the number of web browsers selected by the user. In certain embodiments, the server can instruct the client machines directly to launch agent programs, and the corresponding virtual desktops and web browsers. Resources of the system have to be analyzed to determine if there are no errors. A client machine may be selected to receive a particular set of test scripts to be tested on particular types of web browsers, but errors may arise if the client machine fails to set up the agent programs to run the browsers or if there are other problems in setting the virtual desktops. In such circumstances, the assigned test script may not be executed. In other instances, a client machine may be scheduled to receive a test script, however errors may arise if the client machine is not in networked communication with the server and/or if the selected client machines are not configured to run the selected web browsers. In such circumstances, the assigned test script may not be executed, and the user may be contacted regarding possible changes to the selection. In certain embodiments, the driver program may cause the server to transmit the requisite corrective software to the client machines, and then instruct those client machines to install the corrective software, so that the selected test scripts can be received and executed by the client machines.

In step 302, the test scripts are transmitted from the server to the client machine. In some embodiments, the test scripts are transmitted from the server to a controller program on the client machine. In step 303, the agent programs with individual selected web browsers are launched. In step 304, the test scripts are assigned to each agent program for execution. In some embodiments, the controller program initiates the execution of the test scripts by reaching out to each of the agent programs. In some embodiments, each agent program fetches one or more test scripts from test file based on priority and executes these test scripts on its respective web browser. The controller program may monitor the execution of the test script by the agent program, which may be executed using a framework software module for building and testing software code, such as a software development kit (SDK), and/or an integrated development environment (IDE), among others. The agent program is capable of testing code using test scripts on the different user selected browsers and returning the results to the controller program.

Each virtual desktop uses an agent program to run test scripts using a web browser; for example, if the user selects testing a set of test scripts for an application on three different browsers, the driver program is configured to communicate with the controller program for the creation of three different virtual desktops, each with its own agent program running a set of user selected test scripts on a particular user selected browser. As shown in step 304, the driver program then sends one or more selected test scripts to the controller program on the client machine. These test scripts can be sent in the form of a test file. The controller program then first checks the error queue. An error queue is created to contain failed test scripts, which need to be treated as critical. For example, the error queue can be a database containing test scripts that failed to be executed on a particular web browser and can be part of the server, however the error queue may reside on a different computing device than the server computer, such as a client machine. If there are tests in the error queue, the controller assigns these tests to those agent programs which not yet executed those tests. If all agent programs have executed these particular tests, then the controller updates the result file and removes them from the error queue. This result file is then transmitted back to the user through the driver program or the server.

In certain embodiments of the invention, the user interface has an input field prompting the user to explicitly determine each test script's priority. Test script identifiers associated with these selections are then stored on the test file. The test file is transmitted to a driver computer where a driver program (e.g., framework, IDE, SDK) will read the test file to determine test scripts that need to be retrieved from the test script repository. The test file can be in any file format. The records in the test file comprise test script identifiers and a test script execution priority based on the developer's input at the request page. The driver program reads and loads the required test script from test repository and sends it over to the controller program of the client machine. The controller then initiates the execution of one or more test scripts from the test script repository by reaching out to each of the agent programs. Each agent program fetches one or more test scripts from test file based on priority and execute these test scripts on its respective web browser.

The controller program may monitor the execution of the test script by the agent program, which may be executed using a framework software module for building and testing software code, such as a software development kit (SDK), and/or an integrated development environment (IDE), among others. The agent program is capable of testing code using test scripts on the different user selected browsers and returning the results to the controller program, as in step 305.

Script execution results may be a pass (successful), a fail (unsuccessful), or an error (e.g., unavailable resources). It should be appreciated that the manner such results are reported may vary, for example reporting the color green for a successful test script execution or the color red for an error. The result of a test script may be stored into a non-transitory machine-readable storage medium, such as a computer file or memory. When the agent program executes a particular test script and no error or failure is generated, that test script is marked as pass or success as in step 307 and the results are communicated to the controller program. The records in the successful or pass script list may contain, at least, the script ID of the script that was successful during execution, as well as the identification of the web browser than executed it. Other information that can be transmitted as part of the results record include identification of the client machine, time stamps, user identification, status of the network, and other system information.

The execution of the test scripts may sometimes result in two types of failure—partial fail (as shown in step 311) and full fail (as shown in step 315). For example, without limitations, a partial fail results when the screen resolution does not match the required resolution to successfully execute the test script. For example, a partial fail results when some text is not completely visible or missing in web page following the execution of the test script. Another example for a partial fail includes an instance where some text or image is malformed in the web page following the execution of the test script. For example, without limitations, a full fail results when a functionality of the test script fails to perform in the desired manner. In certain embodiments, the test script is designed in such a manner that at the end of its execution, it communicates the results to its agent program. A partial fail or a full fail is determined by the developer of the test script and once the agent program communicates with the controller program, changes can be implemented to address the partial fails.

In some embodiments, when the execution of a test script results in a partial fail, such as some text not completely visible or missing in a web page, the agent program communicates to the controller or to the server as designed and also shown in step 312. The agent program then receives corrective instructions from the controller or the server as designed and also shown in step 313. For example, such corrective instructions could include changing the existing resolution of the particular virtual desktop to resolution from guidelines defined by user. The agent program then in step 314 runs the test script again on that browser. The new results are then communicated to the controller or the server as in step 306. These instances are considered partial fails.

In some embodiments, when the execution of a test script results in a partial fail, such as some text not completely visible or missing in web page, the agent program changes the existing resolution of the particular virtual desktop to a resolution from resolution guidelines defined by user and runs the test script again on that browser. For example, the resolution of the virtual desktop is 800 by 600 and after the execution of a test script, it appears that the intended result has been achieved but some part of the result is not completely visible or missing. In some instances, the execution of the test script may result in a message indicating that the function was completed, but this message is not completely visible or the images are malformed. These instances are considered partial fails. In some embodiments of the invention, the agent program is configured to detect the partial fail, change the resolution of the virtual desktop, re-execute the test script, and confirm that the message is now completely visible. The new results are then communicated to the controller. In some embodiments of the invention, the agent program is configured to rerun the test scripts, which result in partial fails, for a specified number of times, before classifying the result as a full fail and communicating it back to the controller or the server.

In some instances, the execution of the test script may result in no message or a message indicating that the function was not completed. These instances are considered full fails, as depicted in 315. When the execution of a test script results in a full fail, the agent communicates the result to the controller program, as depicted in 316. In turn, the controller program will put that details of the execution of the test script into an error queue and communicates with the driver program. Details of the execution of the test script can include for example the failure of the particular test script in a particular browser in a particular virtual desktop. This fail can result in the controller program requesting one or more of the other agent programs to run the particular test script, then collecting the results of the execution of the test script by the other agent programs and communicating them back to the user through the driver program. The failed test scripts can be managed and administered through an error queue. For example, the error queue can be a database containing test scripts that failed to be executed on a particular web browser and can be part of the server, however the error queue may reside on a different computing device than the server computer, such as a client machine.

After completing the execution of a test script, each agent program fetches one or more test scripts from test file based on priority and execute these test scripts on its respective web browser until there are no more selected test scripts in the test file for execution. In some embodiments, after checking if all of the user's selected test scripts in the test file have been executed as in step 308, the agent program fetches or is assigned any unexecuted test scripts in the test file or in the error queue and/or updated test script selections from the user, as in step 317. The agent program execute these test scripts on its respective web browser, as in step 305, until there are no more selected test scripts in the test file for execution, and the testing is complete as in step 309. In an embodiment, whenever any agent program communicates with the controller program, the details in this message from the agent program are communicated by the controller program to the driver program. In an embodiment, a user can watch the execution status of test scripts across different browsers through an interface facilitated by the driver program in the server.

Results from the agent programs executing the test scripts on one or more client machines are collected and stored as a results record, as in 310. Although the results record is a logical component of the server computer, in some embodiments the results record may reside on a separate device, including the client machines. Depending upon the embodiment, the results record could be a database, a spreadsheet, a text file, or any other non-transitory machine-readable storage for storing an updatable set of results.

The results produced by each agent program for the test scripts may be in the form of an execution result, an event log, or screenshots, or combinations thereof. In some embodiments, the agent program or the controller program monitoring the test script execution may generate an event log containing information describing the execution of the test script. In certain embodiments, the event logs may contain screenshots of the real-time information display of the results of the test script's execution, thereby capturing the visual information display for user's review.

A results record may be updated according to a result of the executed test scripts from the different agent programs. The results records may be presented on a results page of the user interface. The results page may present the results records according to various settings predetermined by the user. The results records may be queried in order to present various informative views of the information contained in the results records. In some embodiments, the controller program may update the results record according to a result received from the agent programs that executed the test script, and convey the results record to the driver program. The controller program may update the results record stored in a memory of the client machine, the server or another computing device. In some embodiments, results record may be updated after each test script listed in the test file is executed. The results record may be periodically updated, after a number of test scripts are executed. The results record may store a result for each test script. The results record of a test script may comprise a result status indicating the result of execution (e.g., pass, fail, error), an event log describing the execution of test script, and screenshot capturing a still image of a visual information display.

The client machines may execute test scripts corresponding to assigned script IDs. The client machines may transmit the results to a server. The server may then update a results record with the script ID associated with the test script executed and with the result indicating whether the test script passed or failed or partially failed or has an error. In some embodiments, a results record may reflect whether each test script associated with the listed script IDs, failed or succeeded when they were executed by the respective client machines. It is therefore possible to determine how a test script performed when executed on a particular web browser as the agent programs may execute the test scripts on a variety of web browsers. As an example of operation, the server computer may update the results list with a failed-script list each time an agent program reports that a script execution fails. Scripts that fail a first time are re-assigned to remaining agent programs that then determine whether these failed scripts will fail across each browser type. The failed-script list is again updated after each previously failed script is run by the remaining agent programs.

In an embodiment of the invention, a results page of a user interface may be updated according to an updated results record. A results record underlies the results page such that the results record provides content for dynamically generating the results page for display. The developer may review the results page after the underlying results records are updated to assess the efficacy of the software code and the test scripts selected for testing.

In an embodiment of the invention, a controller program may determine whether a user has requested changes to the test script execution plans found in the existing test file. In some embodiments, a user may request changes to the test file while the agent programs are executing the test scripts. That is, the agent programs will continuously fetch and execute test scripts in a batch, in the order indicated by the test file. The user may request that the test file be changed before an agent program completes the test file (i.e., executes each of the listed test scripts). In some embodiments, a user may issue requests to change the test file using a user interface. The requests are conveyed by the driver programs to the controller program that then coordinates with the agent programs to affect the user requested change. The agent programs may complete execution of a test script and then, before fetching the next test script, check whether a request for changes was received from the user interface.

An agent program executing test scripts may determine whether there are any unexecuted test scripts listing in the test file. Test scripts listed by the test file are expected to be executed at least once. Embodiments of the invention include determining whether each test script listed in the test file has been retrieved and executed at least once by the number and type of web browsers selected by the user.

The server reports the results to the user interface in a medium that is either useable, or readable by the user. In some embodiments, readable output may include outputting the results to a user interface of a device connected to the server so that the results may be presented to the user in a human-accessible format. In other embodiments, the results may be output to a useable medium, such as programming code or a binary stream containing the results from the database. The medium may be packaged in, or otherwise capable of being converted to, formats compatible with downstream data processing applications. As an example, outputting the results to an XML file that is accessible for consumption and processing by another computer program.

In Example 1, a user selects, using a user interface, four test scripts from a test script repository and selects a client machine to run the selected test scripts on three web browsers-Chrome, Firefox, and Internet Explorer. The driver program in the server communicates with the client machine and initializes its platforms for executing the test scripts. The driver program communicates with the client machine's controller to create three virtual desktops and corresponding three agent programs. So on each client machine, there will be three virtual desktops, each with its own agent program-one testing the four scripts using a Chrome web browser, one testing the four scripts using a Firefox web browser, and one testing the four scripts using a Internet Explorer web browser. If the agent program executing the test scripts on the Chrome browser executes the second and third test scripts, and returns a full fail for the third test script on the Chrome web browser, then the third test script is placed in an error queue. The controller then prioritizes this test script and assigns the third test script a higher priority than the second test script for the agent programs who have not executed the second script yet. After execution of all four test scripts, the agent programs transmit to the controller the respective execution results from the test script execution, indicating “full fail” or “pass,” or the like.

Execution results in Example 1 are stored in machine-readable results sheet, but in other embodiments there may be other means of storing such execution results (e.g., databases). After receiving execution results, the controller in Example 1 updates a results record, to reflect the script execution results received from agent programs in the client computer. The results sheet in Example 1 is a text file listing execution results as rows of text. As shown by Table 1, the fields in an exemplary result sheet are “timestamp,” “script ID,” “Browser ID,” and “execution result.” In this example, the test scripts are executed by agent programs using Chrome, Firefox, and Internet Explorer web browsers. The resulting entries into the result sheet are shown in Table 1:

TABLE 1

| Timestamp | Script ID | Browser ID | Execution Result |
|---|---|---|---|
| 1/1/2014 1:10 | S1 | AP-Chrome | PASS |
| 1/1/2014 2:05 | S2 | AP-Chrome | PASS |
| 1/1/2012 2:30 | S3 | AP-Chrome | FULL FAIL |
| 1/3/2014 6:35 | S4 | AP-Chrome | PASS |
| 1/1/2014 2:45 | S1 | AP-Firefox | PASS |
| 1/1/2014 3:15 | S3 | AP-Firefox | PASS |
| 1/2/2014 2:30 | S2 | AP-Firefox | PARTIAL FAIL |
| 1/2/2014 10:05 | S2 | AP-Firefox | PASS |
| 1/3/2014 1:10 | S4 | AP-Firefox | PASS |
| 1/1/2014 3:30 | S1 | AP-Internet Explorer | PARTIAL FAIL |
| 1/1/2014 4:05 | S1 | AP-Internet Explorer | PASS |
| 1/1/2014 11:10 | S3 | AP-Internet Explorer | PASS |
| 1/2/2014 5:45 | S2 | AP-Internet Explorer | PASS |
| 1/2/2014 7:30 | S4 | AP-Internet Explorer | PASS |

Results of the test scripts in Example 1 show that test script S3 failed on the Chrome browser, but as the agent programs AP-Firefox and AP-Internet Explorer had not yet started testing test script S2, the controller has assigned S3 to be tested ahead of S2 by both of them. Results of the execution of the test scripts in Example 1 also show that S2 initially resulted in a partial fail by AP-Firefox, and was later resolved to show a “pass” result. Similarly, S1 initially resulted in a partial fail by AP-Internet Explorer, and was later resolved to show a “pass” result.

Embodiments of the invention present several advantages over existing systems. The time and financial resources required to test web applications on multiple browsers are significantly reduced because the embodiments of the invention do not follow the existing systems that follow sequential method of test execution, and also find bugs sooner than existing systems because of the fail classification execution method. The effective utilization of resources by certain embodiments of the invention also results from elimination of the need for least one system per browser to test web applications in a parallel mode.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. The invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein. While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method comprising:
receiving, by a server, a plurality of testing selections, the plurality of testing selections indicating one or more test scripts from a test script repository and identifying a plurality of web browsers to execute the one or more test scripts on one or more client machines;
transmitting, by the server, to each of the one or more client machines instructions to launch the plurality of web browsers;
distributing, by the server, the one or more test scripts to each respective web browser on each of the one or more client machines, the plurality of web browsers executing the one or more test scripts transmitted by the server from the test script repository; and
receiving, by the server, from the one or more client machines one or more results of executing the one or more test scripts by each of the plurality of web browsers of the respective client machine.

2. The method according to claim 1, wherein each of the one or more results further indicate identity of each of the plurality of web browsers associated with the success or failure of executing the one or more test scripts.

3. The method according to claim 1, wherein the one or more results of executing the one or more test scripts by each of the plurality of web browsers is one or more of the following: pass, partial fail, full fail, and error.

4. The method according to claim 1, wherein the one or more results of executing the one or more test scripts by one among the plurality of web browsers is a partial fail when text is missing or not completely visible from one or more test script products, the test script product being obtained by executing the one or more test scripts by one among the plurality of web browsers.

5. The method according to claim 1, wherein the one or more results of executing the one or more test scripts by one among the plurality of web browsers is a full fail when the one or more test scripts fail to be executed in a desired manner by one among the plurality of web browsers.

6. The method according to claim 1, further comprising the step of communicating, by the server, the one or more results through an electronic interface responsive to the plurality of testing selections.

7. The method according to claim 1, further comprising:
determining, by the server, whether the one or more client machines includes a framework module configured to execute the one or more test scripts; and
transmitting, by the server, the framework module to the one or more client machines responsive to determining the one or more client machines do not contain the framework module.

8. The method according to claim 1, further comprising:
determining, by the server, whether the one or more client machines includes a framework module configured to launch a plurality of web browsers on each of the one or more client machines; and
transmitting, by the server, the framework module to the one or more client machines responsive to determining the one or more client machines do not contain the framework module.

9. A system for executing one or more test scripts in parallel across a plurality of web browsers, the system comprising:
a test script repository storing one or more test scripts in a non-transitory machine-readable storage memory;
a server receiving a plurality of testing selections, the plurality of testing selections indicating one or more test scripts from the test script repository and identifying a plurality of web browsers to execute the one or more test scripts on one or more client machines, wherein the server is further configured to transmit the plurality of testing selections to one or more client machines, and receive from the one or more client machines one or more results of executing the one or more test scripts by each of the plurality of web browsers;
the one or more client machines executing the one or more test scripts using a plurality of web browsers responsive to the receiving the plurality of testing selections from the server; and
one or more electronic interfaces configured to display to a user thereof the one or more results received by the server responsive to the plurality of testing selections.

10. The system according to claim 9, wherein the one or more client machines further contain one or more agent programs, each of the one or more agent programs configured to execute the one or more test scripts using one among the plurality of web browsers responsive to the receipt of the plurality of testing selections.

11. The system according to claim 10, wherein each of the one or more agent programs is further configured to execute each of the one or more test scripts based on an associated priority.

12. The system according to claim 11, wherein the associated priority for each of the one or more test scripts is determined by the user.

13. The system according to claim 10, further comprising one or more results records, wherein one or more results records are updated by one or more agent programs with one or more results of executing the one or more test scripts by each of the plurality of web browsers.

14. The system according to claim 13, wherein each of the one or more results further indicate identity of each of the plurality of web browsers associated with the one or more results of executing the one or more test scripts.

15. The system according to claim 13, wherein the one or more results of executing the one or more test scripts by each of the plurality of web browsers is one or more of the following: pass, partial fail, full fail, and error.

16. The system according to claim 13, wherein the one or more results of executing the one or more test scripts by one among the plurality of web browsers is a partial fail when text is missing or not completely visible from one or more test script products, the test script product being obtained by executing the one or more test scripts by one among the plurality of web browsers.

17. The system according to claim 13, wherein the one or more results of executing the one or more test scripts by one among the plurality of web browsers is a full fail when the one or more test scripts fail to execute in a desired manner by one among the plurality of web browsers.

18. The system according to claim 9, further comprising one or more error queues, the one or more error queues configured to store and manage the one or more test scripts resulting in a full fail, the one or more test scripts having failed to execute in a desired manner by one among the plurality of web browsers
